(19) United States
(12) Patent Application Publication
(10) Pub. No.: US 2025/0337111 A1
(43) Pub. Date: Oct. 30, 2025

(54) ELECTRODE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Ho Sung YANG, Suwon-si (KR); Duck Jae YOU, Suwon-si (KR); Chang Won PARK, Suwon-si (KR); Ji Ye WOO, Suwon-si (KR); Hyo Jung SONG, Suwon-si (KR); Kyo Seon KOO, Suwon-si (KR)

(73) Assignee: SAMSUNG SDI CO., LTD., Yongin-si (KR)

(21) Appl. No.: 19/193,462

(22) Filed: Apr. 29, 2025

(30) Foreign Application Priority Data
Apr. 30, 2024 (KR) 10-2024-0057506

(51) Int. Cl. H01M 50/451; H01M 4/02; H01M 4/133; H01M 4/587; H01M 4/62; H01M 10/0525; H01M 50/414; H01M 50/434; H01M 50/44; H01M 50/491

(52) U.S. Cl. CPC H01M 50/451; H01M 4/133; H01M 4/587; H01M 4/622; H01M 10/0525; H01M 50/414; H01M 50/434; H01M 50/44; H01M 50/491; H01M 2004/027

(57) ABSTRACT

The present disclosure relates to an electrode for a rechargeable lithium battery, and a rechargeable lithium battery including the electrode. The electrode for a rechargeable lithium battery includes an active material layer for a rechargeable lithium battery, and an organic layer integrated with the active material layer. The organic layer includes a sea-island region including an island region and a sea region, and the area percentage of the island region in the sea-island region is in a range of about 1% to about 20%.

### CROSS-REFERENCE TO RELATED APPLICATION

The present application claims priority to Korean Patent Application No. 10-2024-0057506, filed on Apr. 30, 2024 in the Korean Intellectual Property Office, the entire disclosure of which is incorporated herein by reference.

### BACKGROUND

### 1. Field of the Disclosure

The present disclosure relates to an electrode for a rechargeable lithium battery, and to a rechargeable lithium battery including the electrode.

### 2. Discussion of Related Art

With the spread of electronic devices that use batteries, such as, e.g., mobile phones, laptop computers, electric vehicles, and the like, the demand for rechargeable batteries with high energy density and high capacity has increased. Accordingly, improving the performance of rechargeable lithium batteries may be advantageous.

A rechargeable lithium battery typically includes a positive electrode and a negative electrode, at least one of the electrodes including an active material capable of intercalation and deintercalation of lithium ions, and an electrolyte, and produces electrical energy through oxidation and reduction reactions when lithium ions are intercalated to, and deintercalated from, the positive electrode and the negative electrode. In an example embodiment of the present disclosure, an electrode for a rechargeable lithium battery includes an organic layer integrated with the active material layer, wherein the organic layer has a high adhesion to the active material layer and a low heat shrinkage rate, and may increase battery life retention rate.

In another example embodiment of the present disclosure, a rechargeable lithium battery includes the electrode for a rechargeable lithium battery.

### SUMMARY OF THE DISCLOSURE

An example embodiment of the present disclosure includes an electrode for a rechargeable lithium battery.

The electrode for a rechargeable lithium battery includes an active material layer for a rechargeable lithium battery and an organic layer integrated with the active material layer. The organic layer includes a sea-island region consisting of or including an island region and a sea region, and the area percentage of the island region in the sea-island region is in a range of about 1% to about 20%.

Another example embodiment of the present disclosure includes a rechargeable lithium battery.

The rechargeable lithium battery includes the electrode for a rechargeable lithium battery, and a second electrode for a rechargeable lithium battery facing the electrode.

In the electrode for a rechargeable lithium battery according to an example embodiment of the present disclosure, since the organic layer, which can replace conventional separators, is integrated with the active material layer, there is no need to perform a lamination process to combine the separator and the active material layer, and thus a battery can be manufactured more economically.

In the electrode for a rechargeable lithium battery according to an example embodiment of the present disclosure, the organic layer has a high adhesion to the active material layer, has a low heat shrinkage rate, and increases battery life retention rate, thereby increasing the stability and reliability of the rechargeable lithium battery.

### BRIEF DESCRIPTION OF THE DRAWINGS

The above and other objects, features and advantages of the present disclosure are more apparent to those of ordinary skill in the art by describing example embodiments thereof in detail with reference to the accompanying drawings, in which:

FIG. 1 is a cross-sectional view of an electrode for a rechargeable lithium battery according to an example embodiment of the present disclosure;

FIG. 2 is a cross-sectional view of an electrode for a rechargeable lithium battery according to another example embodiment of the present disclosure;

FIGS. 3 to 6 are cross-sectional views schematically showing a rechargeable lithium battery according to an example embodiment of the present disclosure;

FIG. 7 are a set of scanning electron microscopy (SEM) images of the electrode for a rechargeable lithium battery according to Example 1;

FIG. 8 are a set of SEM images of the electrode for a rechargeable lithium battery according to Comparative Example 1;

FIG. 9 are a set of SEM images of the electrode for a rechargeable lithium battery according to Comparative Example 2;

In FIGS. 7 to 9, the left is an image of the sea-island region in the organic layer, and the right is an enlarged image of the sea region on the left; and

FIG. 10 shows the results of evaluating the battery capacity according to the number of battery cycles in Example 1 (solid line) and Comparative Example 1 (dotted line).

### DETAILED DESCRIPTION

Hereinafter, example embodiments of the present disclosure are described in detail. However, the embodiments are presented as examples, the present disclosure is not limited thereby, and the present disclosure is only defined by the scope of the claims described below.

Unless otherwise specified herein, when a part such as a layer, a membrane, a region, a plate, and the like is said to be “on” another part, this refers not only to the case where the part is “directly on” the other part, but also to the case where there is another part therebetween.

Unless otherwise specified herein, the singular may also include the plural. In addition, unless otherwise specified, “A or B” may indicate “including A,” “including B,” or “including A and B.”

In this specification, a “combination thereof” may refer to a mixture of components, a laminate, a composite, a copolymer, an alloy, a blend, a reaction product, and the like.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

The electrode for a rechargeable lithium battery according to an example embodiment (hereinafter referred to as “electrode”) includes an active material layer for a rechargeable lithium battery, and an organic layer integrated with the active material layer. The organic layer includes a sea-island region consisting of or including an island region and a sea region, and the area percentage of the island region in the sea-island region is in a range of about 1% to about 20%.

### Organic Layer:

The organic layer is located between the electrode for a rechargeable lithium battery and another electrode, or a second electrode, facing the electrode, and may constitute a separator to reduce or prevent short circuits.

The rechargeable lithium battery including the electrode according to an example embodiment does not include a separator. Therefore, the electrode does not require a lamination process to combine the separator and the electrode when manufacturing batteries such as stack cells, making it possible to manufacture batteries in a simpler and more economical process.

The organic layer is integrated with the active material layer for a rechargeable lithium battery. Here, “integration” indicates that the organic layer is formed directly on the active material layer without any intervening layer therebetween, which refers to a state in which the organic layer is more firmly bonded to the active material layer.

According to an example embodiment of the present disclosure, the organic layer may be formed by permeating into the active material layer and being dried. The integration may reduce or prevent an increase in resistance when lithium ions move.

Through SEM or transmission electron microscopy (TEM) images, it can be confirmed that the active material layer and the organic layer are integrated. According to an example embodiment, in the SEM or TEM images, the active material layer and the organic layer are distinguished from each other, but the integration can be clearly confirmed in that the interface (boundary portion) between the active material layer and the organic layer is not completely distinguished and is typically uneven (unflat).

The organic layer may refer to a layer in which about 90 wt % or more, for example, a range of about 95 wt % to about 100 wt % of the total components forming the layer, are organic components.

According to an example embodiment of the present disclosure, the organic layer may have a thickness ranging from about 1 μm to about 20 μm, for example, from 1 μm to 10 μm. In this specification, the “thickness of the organic layer” refers to the thickness of the region where the organic component is present in a layered form in the organic layer, and does not refer to the thickness of the region where the organic component is present independently or separately. When the thickness of the organic layer is within the above range, an appropriately high density may be achieved.

The organic layer includes nanofibers. According to an example embodiment of the present disclosure, the organic layer includes a plurality of nanofibers, and the organic layer may include some of the nanofibers in a non-woven state, for example, a network structure. An organic layer with a network structure may reduce or minimize resistance when lithium ions move. The organic layer in the non-woven state may refer to a porous layer in which pores are substantially randomly formed between nanofibers. When the organic layer is formed as a dense layer, the movement distance of lithium ions increases, and thus the resistance during the movement of lithium ions relatively increases, which may not be appropriate. According to an example embodiment, the diameter of the pore may be about 90 nm or less, for example, in a range of about 10 nm to about 90 nm.

According to an example embodiment of the present disclosure, the average diameter of the nanofibers may be about 300 nm or less, for example, in a range of about 10 nm to about 200 nm, or about 10 nm to about 100 nm. Within the above range, the organic layer may be readily formed.

The organic layer includes a sea-island region consisting of or including an island region and a sea region. The area of the sea-island region may be about 95% or more, for example, 99% to 100%, or 100% of the total area of the organic layer.

The sea region may be a region where the nanofibers have a non-woven network structure. Since the sea region has pores formed by the nanofibers in the network structure, lithium ions may readily move, and thus it may be possible to reduce or minimize resistance during the movement of lithium ions. According to an example embodiment of the present disclosure, the sea region may be or include a porous region.

The island region is an island-shaped region surrounded by the sea region and may be a region with a predetermined or desired area where the nanofibers are aggregated and/or combined with each other. According to an example embodiment, the island region may be or include a non-porous region that does not include pores formed by the nanofibers, or may be a region in which the average diameter of pores is significantly smaller than the average diameter of the sea region. According to an embodiment of the present disclosure, the island region may be or include a film region composed of or including the nanofibers, in which the nanofibers are formed into a film.

According to an example embodiment of the present disclosure, the island region and the sea region may be integrated and composed of or include the same material. For example, the nanofibers constituting the sea region may be the same type as the nanofibers constituting the island region.

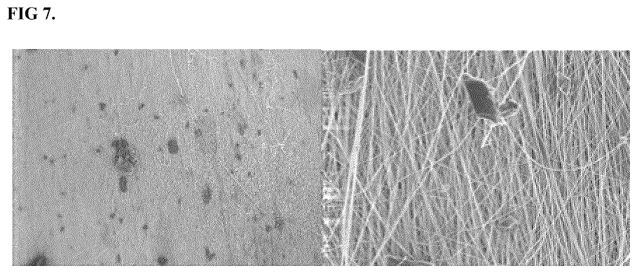

According to an example embodiment of the present disclosure, as shown in FIG. 7, the sea-island region may have a form in which the island region is discontinuously arranged in the sea region.

According to an example embodiment, the island regions have irregular shapes, and may be spaced apart from each other.

An area percentage of the island region in the sea-island region is in a range of about 1% to about 20%. The organic layer consisting of or including only the sea region may have low wet adhesion to the active material layer. In the present disclosure, the organic layer is composed of or includes the sea-island region, but the area percentage of the island region is controlled. When the area percentage of the island region is equal to about 1% or more, the adhesion between the organic layer and the active material layer is high while the heat shrinkage rate is reduced, thereby increasing the stability and lifetime of the rechargeable lithium battery. When the area percentage of the island region is equal to about 20% or less, resistance does not increase when lithium ions move, and thus it is possible to reduce or prevent short circuits of the battery and increase battery life retention rate.

According to an example embodiment of the present disclosure, the area percentage of the island region may range from about 10% to about 20% or from 10% to 15%. The area percentage of the island region in the sea-island region may be measured using a SEM image analyzer, such as, e.g., ImageJ (from the National Institutes of Health and the Laboratory for Optical and Computational Instrumentation (LOCI), Univ. of Wisconsin).

According to an example embodiment, the organic layer may have a heat shrinkage rate in the MD/TD of about 0.1% or less, for example, in a range of about 0% to about 0.1%, and a wet adhesion of about 0.15 gf/mm or more. The heat shrinkage rate and wet adhesion may be measured by the methods described below.

According to an example embodiment, each, or at least one, island region may have an area ranging from about 10 μm² to about 800 μm², for example, from 50 μm² to 150 μm². Within this range, the above-described area percentage may be readily achieved.

The area percentage of the island region may be achieved by using electrospinning when forming the organic layer and controlling the electrospinning conditions, which is described in more detail below.

The nanofibers may include heat resistant polymers. The heat resistant polymer may increase the reliability of the organic layer in the battery. For example, the heat resistant polymer may be or include at least one of polyester, polyamide, polyimide (PI), polyamideimide (PAI), polyetherimide, polyacrylonitrile (PAN), polyvinylidene fluoride (PVDF), polyvinylidene fluoride-hexafluoropropylene (PVDF-HFP), polycarbonate (PC), polyvinyl chloride (PVC), polyvinylidene chloride, polyethylene glycol derivatives, polyoxide, polyvinyl acetate, polystyrene (PS), polyvinylpyrrolidone (PVP), a copolymer thereof, or a combination thereof.

According to an example embodiment, the heat resistant polymer may include one or more of polyvinylidene fluoride (PVDF), polyvinylidene fluoride-hexafluoropropylene (PVDF-HFP), and polyacrylonitrile (PAN).

Hereinafter, a method of preparing the organic layer is described.

The preparation method includes preparing an electrospinning solution including a polymer for nanofibers, and forming an organic layer by electrospinning the electrospinning solution on one surface of the active material layer. The area percentage of the island region in the sea-island region may be realized by controlling the concentration of the polymer in the electrospinning solution, the distance between the nozzle pack and the collecting roller, the internal temperature of the space where electrospinning is performed, and the air pressure in the nozzle. In other words, the lower the concentration of the polymer in the electrospinning solution, the lower the fraction of the polymer with a large difference in solubility constant from the solvent, the more severe the electric field interference, the lower the internal temperature of the space, and the lower the air pressure in the nozzle, the more the volatilization of the solvent included in the electrospinning solution is inhibited, and thus the area percentage of the island region in the sea region may increase.

According to an example embodiment, the electrospinning may be performed by wet spinning. The wet spinning is a method of producing and solidifying fibers by extruding an electrospinning solution prepared by dissolving the polymer in a solvent through a nozzle in a coagulating liquid.

### (1) Preparing the Electrospinning Solution

An electrospinning solution including the polymer and solvent is prepared. The solvent may facilitate the dispersion and dissolution of the polymer to facilitate electrospinning. The solvent may be or include a solvent having a boiling point of about 200° C. or lower, for example, in a range of about 100° C. to about 180° C. Within the above range, the sea-island region that satisfies the above-described island region may be readily manufactured. For example, the solvent may be or include at least one of methylformamide, dimethylacetamide, dimethyl sulfoxide, methylpyrrolidone, and the like, but is not limited thereto. Stirring and/or heat treatment may be additionally performed to increase the dispersion and dissolution of the polymer.

For example, the concentration of the polymer in the electrospinning solution may range from about 5 wt % to about 20 wt % based on 100 wt % of the total electrospinning solution. Within the above range, it may be possible to manufacture the organic layer that satisfies the above-described area percentage of the island region.

### (2) Forming an Organic Layer by Electrospinning the Electrospinning Solution on One Surface of the Active Material Layer

The electrospinning may be preferably performed in a space with an internal temperature of about 25° C. or less, for example, in a range of more than about 18° C. to about 23° C. or less. In the above range, the degree of volatilization of the solvent in the electrospinning solution is lowered, and some residual solvent may remain after electrospinning, making it possible to form the island region.

The electrospinning may be performed by disposing one nozzle pack consisting of or including a tip with a needle size in a range of about 23 gauge to about 30 gauge and a collecting roller at regular intervals, adding the electrospinning solution to the tip, placing the active material layer on the collecting roller, and then applying a voltage in a range of about 35 kV to about 90 kV to the tip. The distance between the nozzle pack and the active material layer may range from about 10 cm to about 20 cm. When the needle of the tip has a size in a range of about 25 gauge to about 30 gauge, the needle of the tip may be appropriate because an organic layer with the desired shape may be formed.

According to the electrospinning process, the electrospinning solution is spun and stretched in the form of a fiber, and a layer including nanofibers may be formed on the electrode plate active material. The electrospinning solution hangs at the end of the tip in the form of a droplet due to surface tension, and when voltage is applied, charges accumulate on the surface of the solution and a repulsive force of the charges occurs. When the critical voltage, at which the repulsion between charges becomes higher than the surface tension of the solution, is reached, a cone-shaped Taylor cone is generated, a jet of electrospinning solution is sprayed from the tip of the cone, and the jet is highly stretched to form nanofibers and collected on the electrode plate, and as a result, the organic layer is formed.

The air pressure of the nozzle may be equal to about 1 MPa or less, for example, in a range of about 0.05 MPa to about 0.8 MPa. Within the above range, the degree to which the solvent is volatilized is reduced so that some residual solvent may remain after electrospinning, making it possible to form the island region.

It may be advantageous to appropriately adjust the tip air so that interference between tips is reduced or minimized, and electrospinning may occur uniformly. The tip air may be adjusted by flowing compressed air at a pressure in a range of about 0.1 MPa to about 0.3 MPa.

The roll speed of the collecting roller may be adjusted so that the organic layer may be formed to an appropriate thickness, and may be, for example, a speed ranging from about 1 m/min to about 3 m/min. In addition, the flow rate of the electrospinning solution discharged from the tip may be adjusted to a range of about 20 μl/min to about 200 μl/min.

In an example embodiment, after performing the electrospinning process, drying may be performed at a temperature in a range of about 20° C. to about 30° C.

In another example embodiment, after performing the electrospinning process, drying may be performed with hot air at a temperature in a range of about 70° C. to about 110° C.

The electrode for a rechargeable lithium battery may further include an inorganic layer integrated with the organic layer.

### Inorganic Layer:

The inorganic layer may be integrated with the organic layer. Herein, “integration” may indicate that one component of the inorganic layer permeates into the organic layer because the inorganic layer is formed directly on the organic layer. The integration may indicate that the interface between the organic layer and the inorganic layer is not completely distinguished and is not flat, and that there may be components that permeate the interface. This may be confirmed by using SEM, TEM, or the like. The integration may improve the electrolyte impregnability of the organic layer and the inorganic layer.

According to an example embodiment, the electrode may include the organic layer and the inorganic layer, sequentially positioned on one surface of the active material layer.

The inorganic layer may include a ceramic as an inorganic material. The ceramic may be advantageous in that the ceramic reduces or suppresses the formation of lithium dendrites. For example, the ceramic may include inorganic materials such as or including at least one of alumina (Al₂O₃), boehmite (aluminum oxide hydroxide), zirconia, titanium oxide (TiO₂), silica (SiO₂), or combinations thereof. According to an example embodiment, the ceramic may be or include one or more of alumina and boehmite. The average particle diameter (D50) of the inorganic material may range from about 100 nm to about 500 nm, for example, from about 100 nm to about 400 nm or from about 100 nm to about 200 nm. Within the above range, the permeability of the organic-inorganic composite layer may be improved.

According to an example embodiment, the inorganic layer may further include an organic material in addition to inorganic materials. The organic material may facilitate the formation of an inorganic layer compared to a layer including only inorganic materials. The organic material may be or include at least one of polyvinylidene fluoride, polyamideimide, polyvinylpyrrolidone, polyacrylonitrile, polyacrylic acid (PAA), polyvinyl alcohol (PVA), a copolymer thereof, or a combination thereof. According to an example embodiment, the inorganic material:organic material weight ratio in the inorganic layer may range from about 10:1 to about 30:1, for example, from about 15:1 to about 25:1. Within the above range, the effect of the inorganic layer may be readily achieved.

According to an example embodiment, the inorganic layer may be or include a dense layer. Here, the “dense layer” is a layer in which the size of pores in the inorganic layer or the degree of pore formation is reduced or minimized. When the inorganic layer is present as a dense layer, the formation of lithium dendrites may be more effectively reduced or suppressed. When the inorganic layer is present as a porous layer, the inorganic layer may be undesirable because short circuits may occur during charging and discharging.

According to an example embodiment, the inorganic layer may have a thickness in a range of about 1 m to about 20 m, for example, about 1 m to about 8 m. In this specification, the “thickness of the inorganic layer” refers to the thickness of the area where the inorganic component is present as a layer in the organic-inorganic composite layer, and does not refer only to the thickness of the area where the inorganic material is present independently or separately. When the thickness of the inorganic layer is within the above range, the inorganic layer may be desired in that the density of the inorganic layer is appropriately increased and thus the generation of lithium dendrites may be somewhat reduced or suppressed.

The inorganic layer may be formed on the organic layer by electrospraying, which is described below. A composition for forming the inorganic layer includes the inorganic material, and may further include one or more of a binder and a solvent. The electrospraying may be performed by disposing one nozzle pack consisting of or including a tip with a needle size in a range of about 23 gauge to about 30 gauge and a collecting roller at regular intervals, adding the composition for forming the inorganic layer to the tip, placing the layer including nanofibers on the collecting roller, and then applying a voltage in a range of about 35 kV to about 90 kV to the tip.

The distance between the nozzle pack and the layer including the nanofibers may range from about 10 cm to about 20 cm. When the tip needle size is in the range of about 25 gauge to about 30 gauge, the tip needle size is desired because an inorganic layer with the desired shape may be formed. The composition for forming an inorganic layer may be sprayed onto the layer in the form of dots through the electrospraying process to form an inorganic layer. The roll speed of the collecting roller may be adjusted so that the inorganic layer may be formed to an appropriate thickness, and the roll speed may range, for example, from about 0.5 m/min to about 3.0 m/min. In addition, the flow rate of the composition for forming an inorganic layer discharged from the tip may be adjusted to a range of about 20 μl/min to about 100 μl/min. The tip air may be adjusted by flowing compressed air at a pressure in a range of about 0.1 MPa to about 0.3 MPa. After the electrospraying process, drying may be performed with hot air at a temperature in a range of about 90° C. to about 110° C.

The inorganic material in the composition for forming an inorganic layer is the same as described above. The solvent may be or include at least one of distilled water, an alcohol such as ethanol, dimethyl acetate, N-methylpyrrolidone, dimethylformamide, acetone, or a combination thereof. The binder may be or include at least one of polyvinylidene fluoride, polyamideimide, polyvinylpyrrolidone, polyacrylonitrile, polyacrylic acid, polyvinyl alcohol, polyacrylic acid, carboxymethyl cellulose, a copolymer thereof, or a combination thereof. In the composition for forming an inorganic layer, the content of the inorganic material may range from about 85 wt % to about 96 wt % based on 100 wt % of the total composition.

### Active Material Layer for Rechargeable Lithium Battery:

The active material for rechargeable lithium battery may be a negative electrode active material layer or a positive electrode active material layer. For example, the active material for rechargeable lithium battery may be or include a positive electrode active material layer.

The positive electrode active material layer may include a positive electrode active material, and may further include a binder and/or a conductive material (e.g., an electrically conductive material). For example, the positive electrode may further include an additive that can be configured as a sacrificial positive electrode.

An amount of the positive electrode active material may be in a range of about 90 wt % to about 99.5 wt % based on 100 wt % of the positive electrode active material layer. Amounts of the binder and the conductive material may be in a range of about 0.5 wt % to about 5 wt %, respectively, based on 100 wt % of the positive electrode active material layer.

The binder is configured to attach the positive electrode active material particles to each other, and to attach the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be included to impart conductivity (e.g., electrical conductivity) to the electrode. Any material that does not cause chemical change (e.g., does not cause an undesirable chemical change in the rechargeable lithium battery), and that conducts electrons, can be included in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material including at least one of copper, nickel, aluminum, silver, and the like, in a form of a metal powder or a metal fiber; a conductive polymer such as a polyphenylene derivative; or a mixture thereof.

The negative electrode active material layer may include a negative electrode active material, and may further include a binder and/or a conductive material (e.g., an electrically conductive material). An amount of the negative electrode active material may be in a range of about 90 wt % to about 99.5 wt % based on 100 wt % of the negative electrode active material layer. Amounts of the binder and the conductive material may be in a range of about 0.5 wt % to about 5 wt %, and in a range of about 0 wt % to about 5 wt %, respectively, based on 100 wt % of the positive electrode active material layer.

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be or include graphite such as non-shaped, sheet-shaped, flake-shaped, sphere-shaped, or fiber-shaped natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles with amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be included in combination with a carbon-based negative electrode active material.

The binder may be configured to attach the negative electrode active material particles to each other, and to attach the negative electrode active material well to the current collector. The binder may include at least one of a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is included as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may be included to impart conductivity (e.g., electrical conductivity) to the electrode. Any material that does not cause chemical change (e.g., does not cause an undesirable chemical change in the rechargeable lithium battery), and that conducts electrons, can be included in the battery. Non-limiting examples thereof may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in a form of a metal powder or a metal fiber; a conductive polymer such as a polyphenylene derivative; or a mixture thereof.

The electrode for the rechargeable lithium battery may further include a current collector.

The current collector may be located on one surface of the active material layer. According to one example embodiment, the electrode may include the active material layer, an organic-inorganic composite layer located on another surface of the active material layer, the entire current collector located on one surface of the active material layer, and another surface of the active material layer. According to one embodiment, the organic-inorganic composite layer may be formed on another side of the entire current collector.

The current collector may be positioned on one side of the active material layer. According to one example embodiment, the electrode may include the active material layer, a current collector positioned on one side of the active material layer, and an organic-inorganic composite layer positioned on the other side of the active material layer. According to one example embodiment, the organic-inorganic composite layer may be formed on the other side of the current collector.

The current collector for the positive active material layer may include an aluminum current collector. The current collector for the negative active material layer may include a material such as or including at least one of a copper foil, a nickel foil, a stainless steel foil, a titanium foil, a nickel foam, a copper foam, a polymer substrate coated with a conductive metal, and a combination thereof.

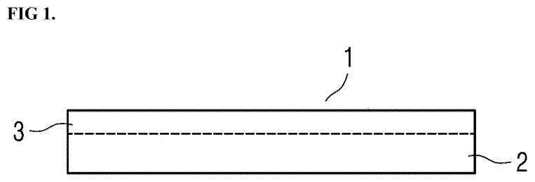

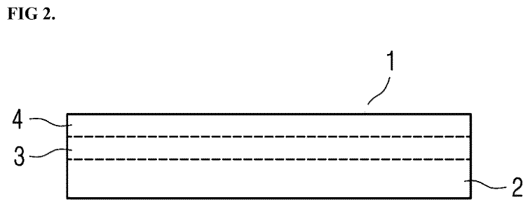

FIG. 1 and FIG. 2 are cross-sectional views of the electrode according to one example embodiment, respectively.

Referring to FIG. 1, the electrode (1) includes an active material layer (2) for a lithium secondary battery, and an organic layer (3) integrated with the active material layer (2) for a lithium secondary battery.

Referring to FIG. 2, the electrode (1) includes an active material layer (2) for a lithium secondary battery, an organic layer (3) integrated with the active material layer (2) for a lithium secondary battery, and an inorganic layer (4) integrated with the organic layer (3).

In FIGS. 1 and 2, the active material layer (2) for a lithium secondary battery and the organic layer (3) are indicated as being formed as separate layers, but this is only a notation to distinguish between the active material layer (2) for a lithium secondary battery and the organic layer (3), and the dotted line indicates that the active material layer (2) for a lithium secondary battery and the organic layer (3) are integrated.

In FIG. 2, the organic layer (3) and the inorganic layer (4) are indicated as being formed as separate layers, but this is only a notation to indicate the organic layer (3) and the inorganic layer (4), and the dotted line indicates that the organic layer (3) and the inorganic layer (4) are integrated.

Another example embodiment is the electrode for a lithium secondary battery; and a lithium secondary battery including an electrode for a lithium secondary battery is provided. In the lithium secondary battery, the electrode for the lithium secondary battery and the electrode for the lithium secondary battery have different electrical characteristics compared to each other. That is, when the electrode assembly for the lithium secondary battery includes a positive electrode for a lithium secondary battery, the electrode for the lithium secondary battery may be a negative electrode. In addition, when the electrode assembly for the lithium secondary battery includes a negative electrode for a lithium secondary battery, the electrode for the lithium secondary battery may be a positive electrode.

Another example embodiment is the electrode for the rechargeable lithium battery; and a lithium secondary battery comprising an electrode for lithium secondary batteries.

In the rechargeable lithium battery, the electrode for the lithium secondary battery is different compared to the electrode for the lithium secondary battery. For example, when the electrode assembly for the lithium secondary battery includes an anode for a lithium secondary battery, the electrode for the lithium secondary battery may be a cathode. In addition, when the electrode assembly for the lithium secondary battery includes a negative electrode for lithium secondary batteries, the electrode for the lithium secondary battery may be an anode.

The rechargeable lithium battery may further include an electrolyte located between the electrode for the rechargeable lithium battery and the electrode for the rechargeable lithium battery.

The electrolyte solution for a rechargeable lithium battery may include a non-aqueous organic solvent and a lithium salt.

The non-aqueous organic solvent may be configured as a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like and the aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be included alone or in combination of two or more solvents.

In addition, when using a carbonate-based solvent, a cyclic carbonate and a chain carbonate may be mixed, and the cyclic carbonate and the chain carbonate may be mixed in a volume ratio in a range of about 1:1 to about 1:9.

The lithium salt dissolved in the organic solvent is configured to supply lithium ions in a battery, to enable a basic operation of a rechargeable lithium battery, and to improve transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers in a range of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

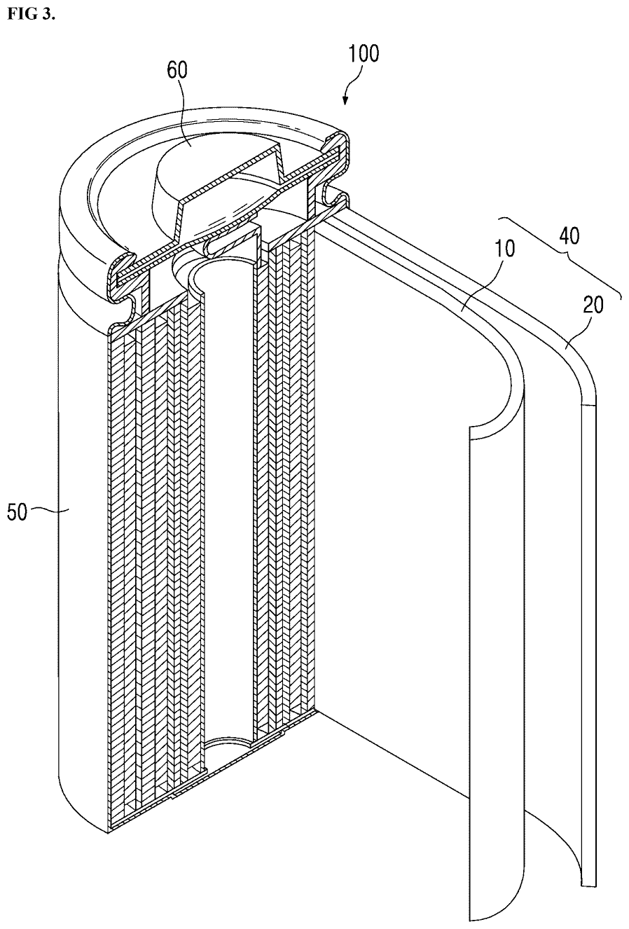

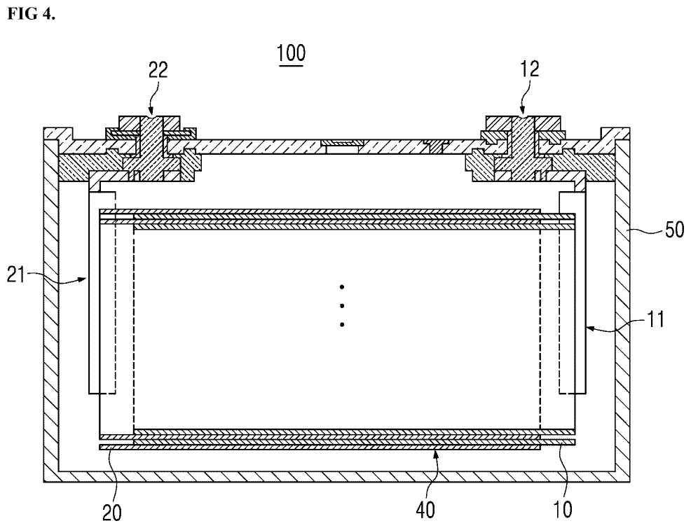

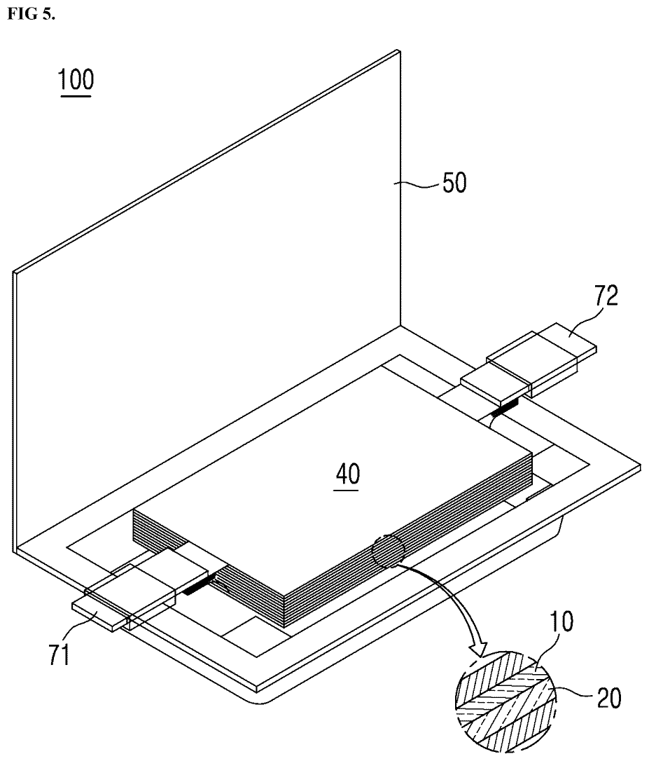

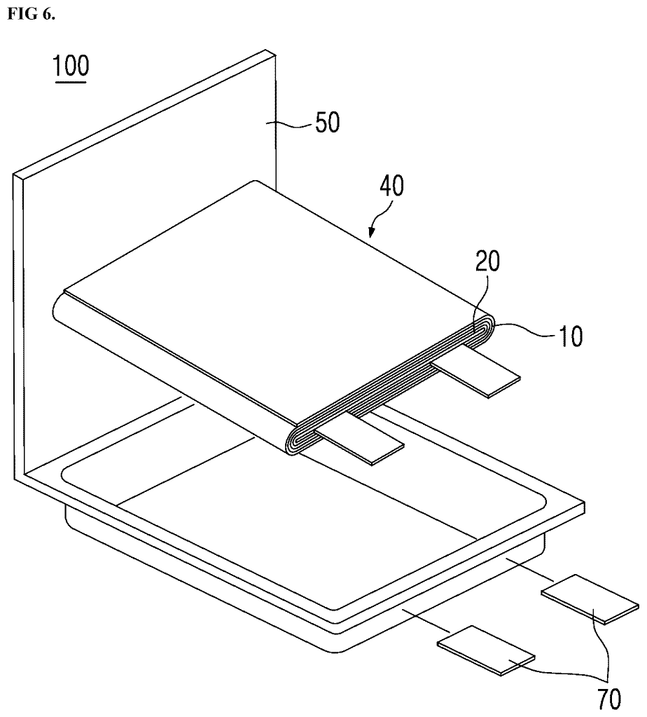

The rechargeable lithium battery may be classified into cylindrical, prismatic, pouch, or coin-type batteries, and the like depending on their shape. FIGS. 3 to 6 are schematic views illustrating a rechargeable lithium battery according to an example embodiment. FIG. 3 shows a cylindrical battery, FIG. 4 shows a prismatic battery, and FIGS. 5 and 6 show pouch-type batteries. Referring to FIGS. 3 to 6, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 3. In FIG. 4, the rechargeable lithium battery 100 may include a positive lead tab 11, a positive terminal 12, a negative lead tab 21, and a negative terminal 22. As shown in FIGS. 5 and 6, the rechargeable lithium battery 100 may include an electrode tab 70 illustrated in FIG. 6, or, for example, a positive electrode tab 71 and a negative electrode tab 72 illustrated in FIG. 5, the electrode tabs 70/71/72 forming an electrical path for inducing the current formed in the electrode assembly 40 to the outside of the battery 100.

The rechargeable lithium battery according to an example embodiment may be applicable to, e.g., automobiles, mobile phones, and/or various types of electric devices, as non-limiting examples.

Hereinafter, examples and comparative examples of the present disclosure are described. The following examples are only an example of the present disclosure, and the present disclosure is not limited thereto.

### Example 1

97.5 wt % of artificial graphite, 1.0 wt % of carboxymethyl cellulose, and 1.5 wt % of styrene butadiene rubber (SBR) were mixed in water, as a solvent, to prepare a negative electrode active material slurry. The negative electrode active material slurry was applied on a copper current collector, dried, and rolled to form a negative electrode active material layer.

Polyvinylidene fluoride-hexafluoropropylene (PVDF-HFP) and polyacrylonitrile (PAN), as polymers for nanofibers, and dimethylacetamide (boiling point: 165° C.), as a solvent, were mixed to prepare an electrospinning solution. The concentration of PVDF-HFP/PAN polymer in the electrospinning solution was 15 wt %. The electrospinning solution was electrospun on the negative electrode active material layer to form an organic layer (thickness: 10 μm) including nanofibers (average diameter: 90 nm).

The electrospinning was performed by the following method:
Internal temperature of the space for electrospinning: 22° C.

After one nozzle pack with a needle size of 25 gauge and a collecting roller were disposed at a distance of 16 cm, the electrospinning solution was added to the tip, a voltage of 40 kV to 75 kV was applied, and then electrospinning was performed. The roll speed of the collecting roller was set at 1 m/min to 3 m/min, and the flow rate of solid content in the composition for forming an organic layer discharged from the tip was set at 150 μl/min. The electrospinning was performed with air pressure by flowing air at a pressure of 0.275 MPa. After electrospinning was completed, drying was performed with hot air at a temperature of 90° C.

Through the above process, a negative electrode was manufactured in which an organic layer (thickness: 10 μm) was integrated with the negative electrode active material layer (area percentage of island region is 15%).

96 wt % of LiCoO₂, 2 wt % of ketjen black, and 2 wt % of polyvinylidene fluoride were mixed in a solvent, N-methylpyrrolidone, to prepare a positive electrode active material slurry. The positive electrode active material slurry was applied on an aluminum current collector, dried, and rolled to manufacture a positive electrode active material layer.

An electrode assembly was manufactured by stacking the manufactured positive and negative electrodes in contact with each other. The organic layer of the negative electrode and the positive electrode active material layer of the positive electrode were disposed in contact with each other. A rechargeable lithium battery (without a separator) was manufactured using the electrode assembly and an electrolyte. The electrolyte was a mixed solvent of ethylene carbonate and ethyl methyl carbonate (50:50 volume ratio) in which LiPF₆ was dissolved.

### Example 2

An organic layer (area percentage of island region is 10%) and a battery were manufactured in the same manner as in Example 1, with a difference that the air pressure was changed from 0.275 MPa to 0.3 MPa when the organic layer was manufactured in Example 1.

### Example 3

An organic layer (area percentage of island region is 20%) and a battery were manufactured in the same manner as in Example 1, with a difference that the distance between the nozzle pack and collecting roller (TCD) was changed from 16 cm to 14 cm when the organic layer was manufactured in Example 1.

### Comparative Example 1

A negative electrode active material layer was formed on the copper current collector in the same manner as in Example 1. A positive electrode active material layer was formed on the aluminum current collector in the same manner as in Example 1. As the separator, a separator from Asahi Kasei Corporation (thickness: 13 μm, in which an inorganic layer including boehmite and an organic binder layer were sequentially formed on a polyethylene-based base film) was used.

The separator was placed between the manufactured negative and positive electrodes, and the manufactured negative and positive electrodes were stacked to manufacture an electrode assembly. The electrode assembly and an electrolyte were used to manufacture a rechargeable lithium battery. The electrolyte was the same as the electrolyte used in Example 1.

### Comparative Example 2

An organic layer (area percentage of island region is 30%) and a battery were manufactured in the same manner as in Example 1, with a difference that the temperature of the internal space where electrospinning was performed was changed from 22° C. to 18° C. when the organic layer was manufactured in Example 1.

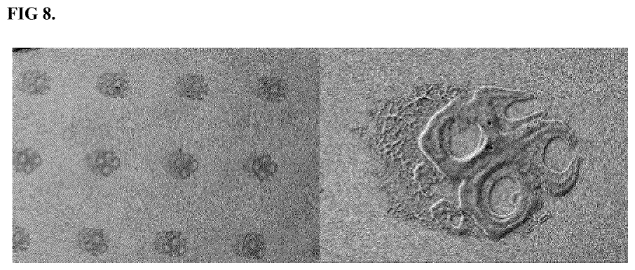

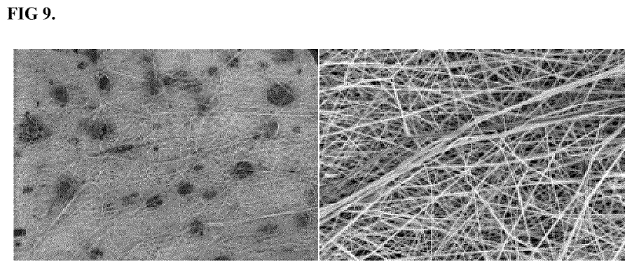

SEM photographs were taken of the negative electrodes including the organic layers manufactured in Examples and Comparative Examples, and the results thereof are shown in FIG. 7 (Example 1), FIG. 8 (Comparative Example 1), and FIG. 9 (Comparative Example 2).

Referring to FIG. 7, the area of the island region in the organic layer of Example 1 was 15%.

Referring to FIG. 8, the adhesive layer of Comparative Example 1 was in the form of an array of dots with a diameter of 200 μm.

Referring to FIG. 9, the area of the island region in the organic layer of Comparative Example 2 was 30%.

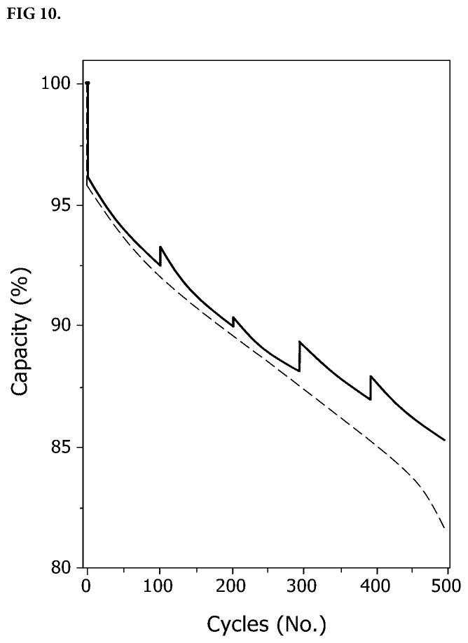

The following physical properties of the negative electrodes and batteries including the same manufactured in Examples and Comparative Examples were evaluated, and the results thereof are shown in Table 1 below and FIG. 10.

(1) Wet adhesion (units: gf/mm): Samples were prepared by cutting each electrode assembly (positive electrode-negative electrode integrated with the organic layer) manufactured in Examples and Comparative Examples into a size of 2.5 cm×8 cm. The prepared samples were placed in a pouch. 2.5 g of a mixed solvent of ethylene carbonate and ethyl methyl carbonate (50:50 volume ratio), in which LiPF₆ was dissolved, was injected as an electrolyte, and the pouch was sealed and left at 25° C. for 12 hours. Afterward, the same was left to stand for 2 hours at a pressure of 200 kgf in a 50° C. chamber. In the sample, the organic layer was separated from the negative electrode plate by about 10 mm to 20 mm, and the separator was fixed to the upper grip and the negative electrode plate was fixed to the lower grip so that the gap between the grips was 20 mm, and then peeled off by stretching in a 180° direction. The peeling speed was 20 mm/min, and after the start of peeling, the force required to peel 40 mm was measured three times and the average value was obtained. The average value of the measured values was calculated.

(2) Heat shrinkage rate (units: %): The organic layer was manufactured in the same manner as in Examples and Comparative Examples. The prepared organic layer-electrode plate was cut into a size of 5 cm×5 cm to prepare a sample. After drawing a 5 cm×5 cm square on the surface of the sample, the sample was sandwiched between paper or alumina powder and left in an oven at 180° C. for 1 hour. After taking out the sample, the dimensions of the sides of the square were measured, and the heat shrinkage rate in the machine direction (MD) and the transverse direction (TD) was calculated.

The heat shrinkage rate was calculated according to Equation 1 below.

$$Heat shrinkage rate = ( L 0 - L 1 ) / L 0 \times 100 \qquad Equation 1$$

In Equation 1 above, L0 is the initial length of the organic layer, and L1 is the length of the organic layer after being left at 180° C. for 1 hour.

(3) Battery life retention rate: A battery was manufactured in the same manner as in Examples and Comparative Examples. The capacity efficiency (units: %) of the manufactured battery was evaluated after one cycle and 500 cycles at 55° C. The conditions of charging and discharging are as follows.
Charging: CC 1.0 C to 4.4 V, CV to 0.01 C
Discharging: CC 1.0 C to 2.75 V

TABLE 1

| | Area | | | | Battery life | |
|---|---|---|---|---|---|---|
| | percentage | | Heat | | retention | |
| | of island | | shrinkage | | rate (%) | |
| | region to | Wet | rate | | 1 | 500 |
| | organic layer | adhesion | MD | TD | cycle | cycles |
| Example 1 | 15% | 0.25 | 0 | 0 | 96 | 86 |
| Example 2 | 10% | 0.15 | 0 | 0 | 96 | 84 |
| Example 3 | 20% | 0.30 | 0 | 0 | 96 | 82 |
| Comparative | — | 0.17 | 0.7 | 1.25 | 95 | 82 |
| Example 1 | | | | | | |
| Comparative | 30% | 0.45 | 0 | 0 | ND | ND |
| Example 2 | | | | | | |

*ND: In Comparative Example 2, since the cell could not be driven, the battery life could not be measured.

As shown in Table 1 and FIG. 10, the electrodes for a rechargeable lithium battery of Examples 1-3 had high adhesion to the active material layer and a low heat shrinkage rate, and can increase the battery life retention rate even after 500 cycles.

On the other hand, in the electrodes of Comparative Examples 1 and 2, which used a conventional separator, the separator had a high heat shrinkage rate. In addition, in Comparative Example 2, which included an organic layer having a sea-island region but had an island region area percentage of 30%, the cell could not be driven.

Although the example embodiments of the present disclosure have been described above, the present disclosure is not limited thereto and can be implemented with various modifications within the scope of the claims, the detailed description of the present disclosure, and the attached drawings, which fall within the scope of the present disclosure.

What is claimed is:

1. An electrode for a rechargeable lithium battery, the electrode comprising:
an active material layer; and
an organic layer integrated with the active material layer,
wherein the organic layer includes a sea-island region comprising an island region and a sea region, and the area percentage of the island region in the sea-island region is in a range of about 1% to about 20%.

2. The electrode of claim 1, wherein:
the sea region comprises a non-woven region of nanofibers, and
the island region comprises a film region composed of nanofibers.

3. The electrode of claim 2, wherein in the sea-island region, the island region is discontinuously disposed in the sea region.

4. The electrode of claim 2, wherein the nanofibers of the sea region are a same type of nanofibers as the nanofibers of the island region.

5. The electrode of claim 2, wherein:
the sea region comprises a porous region, and
the island region comprises a non-porous region or a region in which the average diameter of pores is smaller than the average diameter of pores of the sea region.

6. The electrode of claim 2, wherein the nanofiber comprises at least one of polyester, polyamide, polyimide (PI), polyamideimide (PAI), polyetherimide, polyacrylonitrile (PAN), polyvinylidene fluoride (PVDF), polyvinylidene fluoride-hexafluoropropylene (PVDF-HFP), polycarbonate (PC), polyvinyl chloride (PVC), polyvinylidene chloride, polyethylene glycol derivatives, polyoxide, polyvinyl acetate, polystyrene (PS), polyvinylpyrrolidone (PVP), and a copolymer thereof.

7. The electrode of claim 2, wherein at least one island region has an area in a range of about 10 μm² to about 800 μm².

8. The electrode of claim 2, wherein the nanofiber has an average diameter of about 300 nm or less.

9. The electrode of claim 1, further comprising an inorganic layer integrated with the organic layer.

10. The electrode of claim 1, wherein the active material layer for a rechargeable lithium battery comprises a negative electrode active material layer.

11. The electrode of claim 10, wherein the negative electrode active material layer comprises a carbon-based negative electrode active material.

12. A rechargeable lithium battery comprising:
the electrode for a rechargeable lithium battery of claim 1; and
a second electrode for a rechargeable lithium battery facing the electrode.

13. The battery of claim 12, wherein the rechargeable lithium battery does not comprise a separator.
